(19) United States
(12) Patent Application Publication
(10) Pub. No.: US 2024/0294398 A1
(43) Pub. Date: Sep. 5, 2024

(54) AUTOMATIC WATER FILTERING PURIFYING BOTTLE

(71) Applicant: GUANGZHOU LANQUAN HOUSEHOLD ELECTRICAL APPLIANCE CO., LTD, GUANGZHOU (CN)

(72) Inventor: ZUOGUO CAO, GUANGZHOU (CN)

(21) Appl. No.: 18/460,704

(22) Filed: Sep. 5, 2023

(30) Foreign Application Priority Data
Mar. 3, 2023 (CN) 202310203768.8

(51) Int. Cl. C02F 1/00; A45F 3/16; B65D 43/02

(52) U.S. Cl. CPC C02F 1/002; A45F 3/16; B65D 43/0225; A45F 2003/163; C02F 2201/005; C02F 2307/02

(57) ABSTRACT

An automatic water filtering purifying bottle relates to a technical field of water purification and includes a bottle body and a filter device. The bottle body includes a raw water cavity and a purified water cavity. The raw water cavity and the purified water cavity are sequentially disposed along an axis direction. The bottle body defines a raw water opening and a purified water opening. The raw water opening is capable of being opened and closed. The raw water opening is configured to communicate with the raw water cavity. The purified water opening is capable of being opened and closed. The purified water opening is configured to communicate with the purified water cavity. The filter device is configured to filter water in the raw water cavity and is communicated with the raw water cavity and the purified water cavity.

### TECHNICAL FIELD

The present disclosure relates to a technical field of water purification, and in particular to an automatic water filtering purifying bottle.

### BACKGROUND

At present, most of drinking water comes from rivers or groundwater. According to various test reports in recent years, pollution of water resources is very serious. Especially the groundwater, which is polluted to varying degrees. Therefore, purification and filtration of the drinking water becomes particularly important. When hiking on foot or working in the field, it is unrealistic to carry a large amount of drinking water, but if a traveler drinks mountain spring water or river water directly, there is a great potential safety hazard, and it may even affect the traveler's health. In order to meet a drinking water demand during hiking or working in the field and improve living conditions of the traveler, it is necessary to provide an automatic water filtering purifying bottle.

### SUMMARY

In order to overcome deficiencies of the prior art, an object of the present disclosure is to provide an automatic water filtering purifying bottle, which effectively and automatically filters water to make the water suitable for drinking when people go hiking or working in the field, and is conducive to improving living conditions.

To achieve the above object, the present disclosure provides the automatic water filtering purifying bottle. The automatic water filtering purifying bottle comprises a bottle body and a filter device.

The bottle body comprises a raw water cavity and a purified water cavity. The raw water cavity and the purified water cavity are sequentially disposed along an axis direction. The bottle body defines a raw water opening and a purified water opening. The raw water opening is capable of being opened and closed. The raw water opening is configured to communicate with the raw water cavity. The purified water opening is capable of being opened and closed. The purified water opening is configured to communicate with the purified water cavity. The filter device is configured to filter water in the raw water cavity and is communicated with the raw water cavity and the purified water cavity.

Furthermore, the raw water cavity and the purified water cavity are separated by a partition plate. The partition plate defines a filter mounting hole. The filter device is fixed in the filter mounting hole of the partition plate.

Furthermore, the automatic water filtering purifying bottle further comprises an exhaust device. The exhaust device is configured to maintain an air pressure balance in the raw water cavity and the purified water cavity.

Furthermore, the exhaust device comprises an exhaust pipe. The exhaust pipe is disposed in the raw water cavity and the purified water cavity of the bottle body. The exhaust pipe comprises a pipe cavity, an air inlet, and an air outlet. The air inlet is communicated with the air outlet through the pipe cavity. The air inlet is configured to communicate with the purified water cavity. The air outlet is configured to communicate with the raw water cavity.

Furthermore, a polishing layer or a water guide coating later is coated on an inner wall of the exhaust pipe.

Furthermore, the exhaust device further comprises a check valve. The check valve is configured to discharge air in the purified water cavity from the air outlet of the exhaust pipe to the raw water cavity. The check valve is further configured to limit the water in the raw water cavity to enter the purified water cavity from the air outlet of the exhaust pipe.

Furthermore, the exhaust device further comprises a valve covering assembly. The valve covering assembly is configured to fix the check valve to the exhaust pipe and cover the check valve to limit water from entering the pipe cavity from the air outlet. An exhaust gap is defined between the valve covering assembly and the check valve. The exhaust gap is configured to communicate with the air outlet of the exhaust pipe.

Furthermore, the valve covering assembly comprises a positioning covering piece and a positioning ring. The positioning covering piece is configured to fix the check valve on the exhaust pipe and cover the check valve to limit the water from entering the pipe cavity from the air outlet. The exhaust gap is defined between the positioning covering piece and the check valve. The exhaust gap is communicated with the air outlet of the exhaust pipe. The positioning ring is sleeved in the raw water cavity of the bottle body and is connected to the positioning covering piece to maintain a vertical position of the positioning covering piece in the raw water cavity.

Furthermore, automatic water filtering purifying bottle further comprises a purified water opening lid. The purified water opening lid is detachably connected to the bottle body to open and close the purified water opening.

Furthermore, the purified water opening lid comprises a connecting cover, a flipping cover, and a screwing cap. The connecting cover is detachably mounted on the purified water opening of the bottle body. A movable through hole is defined on the flipping cover. A connecting hole is defined on the connecting cover. The connecting hole is communicated with the purified water cavity through the purified water opening. The screwing cap is rotatable in the movable through hole to be connected to or separated from the connecting cover, so the connecting hole is controlled to open or close.

Compared with the prior art, in the present disclosure, the raw water cavity and the purified water cavity are defined in the bottle body, the raw water opening and the purified water opening are defined on the bottle body, and the filter device is disposed between the raw water cavity and the purified water cavity. The bottle body has two openings, so that raw water is able to enter and flow out of the raw water cavity and purified water is able to enter and flow out of the purified water cavity. When in use, the bottle body is placed upright, that is, a first end of the bottle body close to the raw water cavity faces upwards and a second end of the bottle body close to the purified water cavity is placed downwards. When in use, the raw water opening is exposed, and the raw water (e.g., mountain spring water or river water) to be filtered enters the raw water cavity from the raw water opening of the bottle body. Under action of the filter device, the raw water in the raw water cavity is filtered under gravity. The purified water filtered by the filter device enters the purified water cavity and flows out from the purified water opening for people to drink. The automatic water filtering purifying bottle effectively and automatically filters the raw water to enable the raw water to be suitable for drinking, which is beneficial to improving the living condition of people.

### BRIEF DESCRIPTION OF DRAWINGS

FIG. 1 is a structural schematic diagram of an automatic water filtering purifying bottle of the present disclosure.

FIG. 2 is a cross-sectional schematic diagram of the automatic water filtering purifying bottle shown in FIG. 1.

FIG. 3 is an exploded schematic diagram of the automatic water filtering purifying bottle shown in FIG. 1.

FIG. 4 is a structural schematic diagram of an exhaust pipe body shown in FIG. 3.

FIG. 5 is a structural schematic diagram of a check valve shown in FIG. 3.

FIG. 6 is a structural schematic diagram of a positioning connecting piece shown in FIG. 3.

FIG. 7 is an exploded schematic diagram of a purified water opening lid shown in FIG. 3.

FIG. 8 is another exploded schematic diagram of a purified water opening lid shown in FIG. 3.

FIG. 9 is a structural schematic diagram of a bottle body shown in FIG. 3.

FIG. 10 is an enlarged schematic diagram of portion A shown in FIG. 9.

FIG. 11 is a structural schematic diagram of a flow guide portion.

In the drawings:

1—bottle body; 2—filter device; 3—raw water opening; 4—purified water opening; 5—partition plate; 6—exhaust pipe body; 7—air inlet; 8—air outlet; 10—positioning ring; 11—positioning connecting piece; 12—positioning hole; 13—exhaust port; 14—purified water opening lid; 15—connecting cover; 16—flipping cover; 17—screwing cap; 18—connecting hole; 19—limiting protrusion; 20—flow guide portion; 21—valve inlet; 22—valve outlet; 23—valve connecting piece; 24—water absorbing piece; 25—raw water opening lid; 26—sealing ring; 27—sealing plug; 28—handle; 29—anti-slip portion; 30—positioning covering piece; 31—limiting slope; 32—air inlet positioning portion; 33—valve connecting portion; 34—baffle plate; 35—limiting ring; 36—flow guide inclined opening; 37—first side surface; 38—second side surface.

### DETAILED DESCRIPTION

Some embodiments of the present disclosure will be described in detail, and optional embodiments of the present disclosure are shown in the accompanying drawings. The accompanying drawings help to well understand the description of the specification, so that a person can intuitively and vividly understand each technical feature and an overall technical solution of the present disclosure. It is noted that the accompanying drawings cannot be understood as a limitation to the protection scope of the present disclosure.

It should be understood in the description of the present disclosure that terms such as “upper”, “lower”, “front”, “rear”, “left”, “right”, etc. indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure.

In the description of the present disclosure, the term “a plurality of” means more than two. Terms “greater than”, “less than”, “exceed”, etc., are understood as not including the specific number. Terms “not less than”, “no more than” “within”, etc. are understood as including the specific number. Terms such as “first” and “second” are only used for the purpose of description, rather than being understood to indicate or imply relative importance, hint the number of indicated technical features, or implicitly indicate an order relationship of indicated technical features.

It should be noted in the description of the present disclosure that, unless otherwise regulated and defined, terms such as “installation,” “mount,” and “connection” should be understood in broad sense. For those of ordinary skill in the art, the meanings of the above terms in the present disclosure may be understood according to concrete conditions.

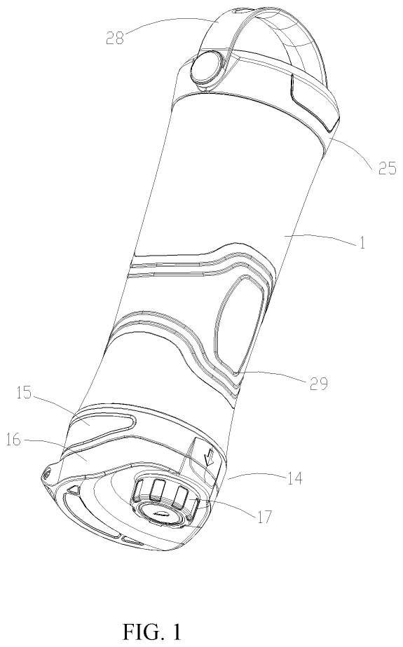

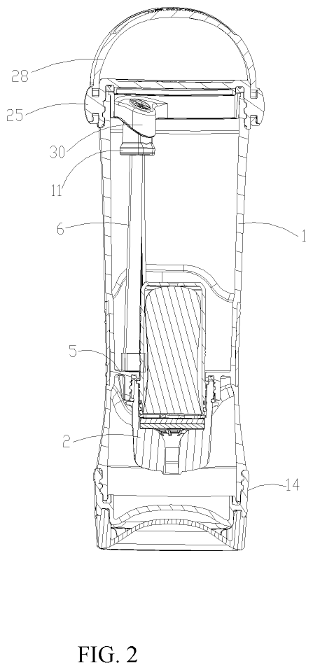

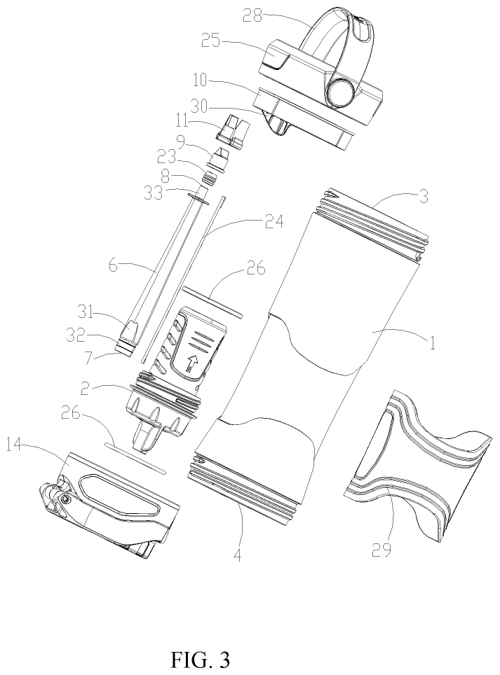

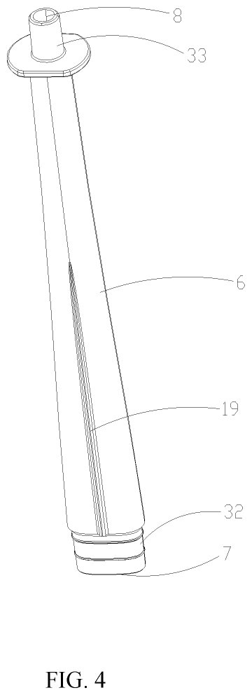

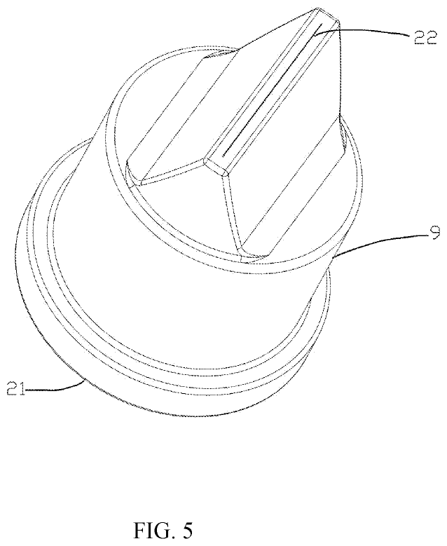

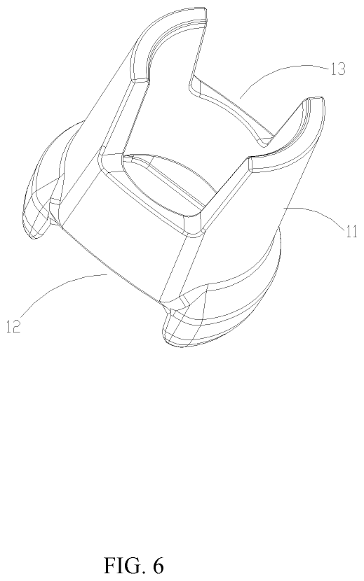

As shown in FIGS. 1-11, one optional embodiment of the present disclosure provides an automatic water filtering purifying bottle. The automatic water filtering purifying bottle comprises a bottle body 1 and a filter device 2.

The bottle body 1 comprises a raw water cavity and a purified water cavity. The raw water cavity and the purified water cavity are sequentially disposed along an axis direction. The bottle body 1 defines a raw water opening 3 and a purified water opening 4. The raw water opening 3 is capable of being opened and closed. The raw water opening 3 is configured to communicate with the raw water cavity. The purified water opening 4 is capable of being opened and closed. The purified water opening 4 is configured to communicate with the purified water cavity. The filter device 2 is configured to filter water in the raw water cavity and is communicated with the raw water cavity and the purified water cavity.

Based on above structures, in the present disclosure, the raw water cavity and the purified water cavity are defined in the bottle body 1, the raw water opening 3 and the purified water opening 4 are defined on the bottle body 1, and the filter device 2 is disposed between the raw water cavity and the purified water cavity. The bottle body 1 has two openings, so that raw water is able to enter and flow out of the raw water cavity and purified water is able to enter and flow out of the purified water cavity. When in use, the bottle body 1 is placed upright, that is, a first end of the bottle body 1 close to the raw water cavity faces upwards and a second end of the bottle body close to the purified water cavity is placed downwards. When in use, the raw water opening 3 is opened, and the raw water (e.g., mountain spring water or river water) to be filtered enters the raw water cavity from the raw water opening 3 of the bottle body 1. Under action of the filter device 2, the raw water in the raw water cavity is filtered under gravity. The purified water filtered by the filter device 2 enters the purified water cavity and flows out from the purified water opening 4 for people to drink. The automatic water filtering purifying bottle effectively and automatically filters the raw water to enable the raw water to be suitable for drinking, which is beneficial to improving the living condition of people.

In the embodiment, the bottle body 1 is integrally formed. A first end portion of the bottle body 1 runs through a first end surface of the bottle body 1 to define the raw water opening 3. A second end portion of the bottle body 1 runs through a second end surface of the bottle body 1 to define the purified water opening 4. The bottle body 1 is integrally formed, which is conducive to improving a sealing performance of the bottle body, and is also conducive to improving a structural strength of the automatic water filtering purifying bottle, so that the automatic water filtering purifying bottle is able to be used in complex outdoor environments.

In other embodiments, the bottle body 1 is of a double-section structure and comprises a raw water section and a purified water section. The raw water cavity is formed in the raw water section. A top portion of the raw water cavity runs through a top surface of the raw water section to form the raw water opening 3. The purified water cavity is formed in the purified water section. A top portion of the purified water cavity runs through a top surface of the purified water section to form the purified water opening 4. The purified water section is connected to a bottom portion of the raw water section by threads, and the purified water opening 4 is controlled to open or close by unscrewing or screwing the purified water section.

In the embodiment, the raw water cavity and the purified water cavity in the bottle body 1 are separated by a partition plate 5. The partition plate 5 defines a filter mounting hole. The filter device is fixed in the filter mounting hole of the partition plate 5, which facilitates an effective fixation of the filter device 2.

In one specific embodiment, an inner wall of the bottle body 1 extends radially to form the partition plate 5. That is, the partition plate 5 and the bottle body 1 are integrally formed, which improves stability of a connection structure thereof.

Specifically, the filter device 2 is screwed with the partition plate 5 by threads, which facilitates disassembly and assembly of the filter device 2.

In other embodiments, the filter device 2 is configured as a component directly separating the raw water cavity and the purified water cavity in the bottle body 1.

In the embodiment, the filter device 2 comprises a water inlet end and a water outlet end. The water inlet end of the filter device 2 is connected to the raw water cavity, and the water outlet end of the filter device 2 is connected to the purified water cavity, so that the raw water in the raw water cavity enters the filter device 2 through the water inlet end to be effectively filtered, and the purified water filtered by the filter device 2 flows out from the water outlet end of the filter device 2 and enters the purified water cavity.

Specifically, the filter device 2 has a filter cavity. The water inlet end is communicated with the water outlet end of the filter device 2 through the filter cavity. A filtering element is disposed in the filter cavity. Optionally, the filtering element may comprise one or more of a silver ion filter element, a PPF cotton filter element, a compressed activated carbon filter element, a living fossil filter element, a far-infrared mineral fossil filter element, a nanocomposite filter element, a carbon fiber filter element, and an ultrafiltration membrane filter element.

In the embodiment, the automatic water filtering purifying bottle further comprises an exhaust device. The raw water in the raw water cavity is fully filtered in the filter device 2 under gravity and then flows into the purified water cavity. As a water level in the raw water cavity drops, the exhaust device replenishes air into the raw water cavity to maintain an air pressure balance in the raw water cavity and the purified water cavity.

The partition plate 5 defines an exhaust mounting hole. The exhaust device is mounted in the exhaust mounting hole, which facilitates an effective fixation of the exhaust device.

In the embodiment, the exhaust device is disposed in the bottle body 1 and is configured to discharge the air in the purified water cavity into the raw water cavity, The exhaust device comprises an exhaust pipe. The exhaust pipe comprises an exhaust pipe body 6. The exhaust pipe body 6 is mounted in the exhaust mounting hole of the partition plate 5 and passes through the raw water cavity and the purified water cavity of the bottle body 1. The exhaust pipe body 6 comprises a pipe cavity, an air inlet 7, and an air outlet 8. The air inlet 7 is communicated with the air outlet 8 through the pipe cavity. The air inlet 7 is configured to communicate with the purified water cavity. The air outlet 8 is configured to communicate with the raw water cavity.

In this way, disassembly and assembly of the exhaust pipe is facilitated, which realizes the discharge of the air in the purified water cavity, so that the raw water in the raw water cavity enter the purified water cavity after being filtered.

In other embodiments, the exhaust pipe is integrally formed with the partition plate 5 on the bottle body 1.

In the embodiment, a limiting slope 31 is defined on one side of the exhaust pipe body 6 close to an inner wall of the bottle body 1. A surface of one end of the exhaust pipe body 6 close to the air inlet 7 is inclined upward toward the air outlet 8 to form the limiting slope 31. Correspondingly, a positioning slope cooperated with the limiting slope 31 is defined on the exhaust mounting hole of the partition plate 5. An inner wall of the exhaust mounting hole of the partition plate 5 protrudes radially to form the positioning slope. The positioning slope of the partition plate 5 is attached to the limiting slope 31 of the exhaust pipe body 6. In this way, mounting of the exhaust pipe body 6 is well guided and the exhaust pipe body 6 is effectively mounted in the exhaust mounting hole of the partition plate 5, so that the exhaust pipe body 6 is mounted close to the inner wall of the bottle body 1, which facilitates the raw water to enter the raw water cavity from the raw water opening 3.

In the embodiment, a limiting protrusion 19 is disposed on one side of the exhaust pipe body 6 away from the inner wall of the bottle body 1. A surface of the exhaust pipe body 6 protrudes radially to form the limiting protrusion 19. The limiting protrusion 19 guides an installation of the exhaust pipe body 6, so that the exhaust pipe body 6 is mounted close to the inner wall of the bottle body 1, which facilitates the raw water to enter the raw water cavity from the raw water opening 3.

In the embodiment, the limiting protrusion 19 extends along an axis of the exhaust pipe body 6, which increases a contact area between the limiting protrusion 19 and the partition plate 5.

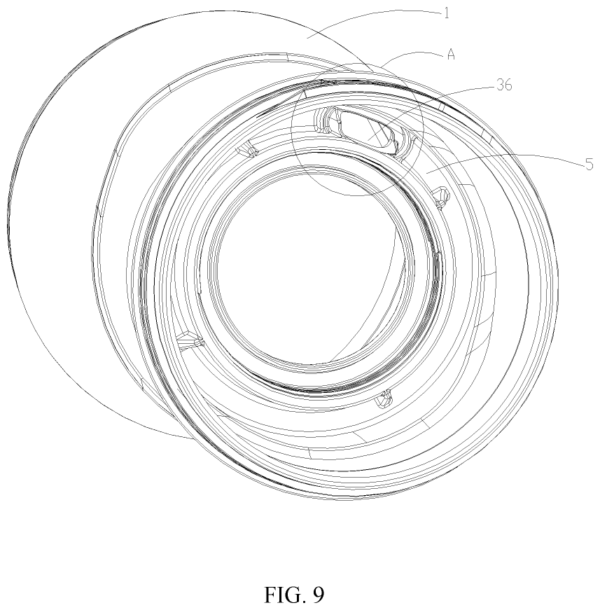

Further, as shown in FIGS. 9-11, the exhaust device further comprises a flow guide portion 20. The flow guide portion 20 is configured to guide water drops in the air inlet 7 of the exhaust pipe body 6 to discharge from the air inlet 7 and flow to the purified water cavity, so that the water drops are effectively prevented from being accumulated in the air inlet 7.

Specifically, the flow guide portion 20 comprises a flow guide inclined opening 36 communicated with the air inlet 7 of the exhaust pipe body 6, so that the flow guide portion 20 plays a role in guiding the water drops in the air inlet 7. The flow guide portion 20 guides the water drops out of the air inlet 7 and flow to the purified water cavity, which effectively prevents the water drops from accumulating in the air inlet 7 to cause blockage, thereby improving exhaust efficiency.

Optionally, a slope inclined relative to the air inlet 7 is defined on one side of the flow guide portion 20. A top portion and a bottom portion of the flow guide inclined opening 36 respectively run through a top surface and a bottom surface of the flow guide portion 20. A side portion of the flow guide inclined opening 36 runs through the slope of the flow guide portion 20. In this way, the flow guide inclined opening 36 is communicated with the air inlet 7 of the exhaust pipe body 6. After the water drops in the air inlet 7 enter the flow guide inclined opening 36 of the flow guide portion 20 under gravity, the water drops easily flow out of the flow guide inclined opening 36 and flow to the purified water cavity, so that the water drops are effectively prevented from being accumulated in the air inlet 7.

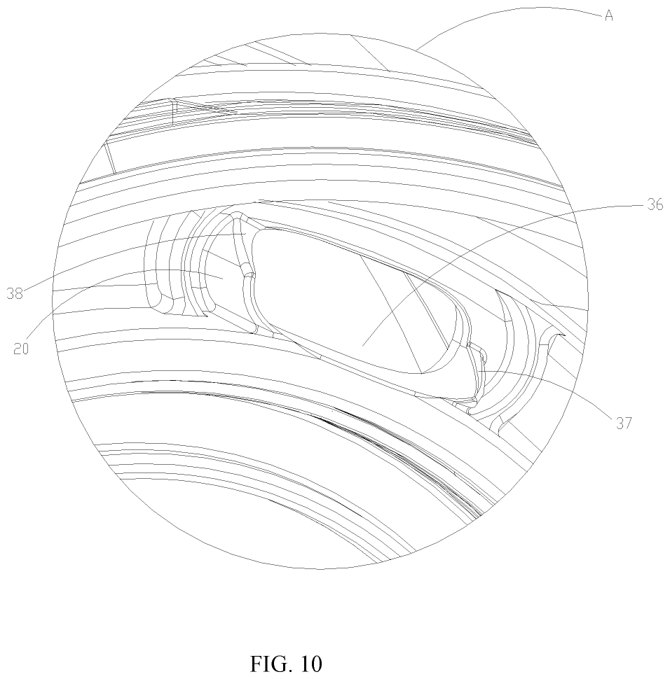

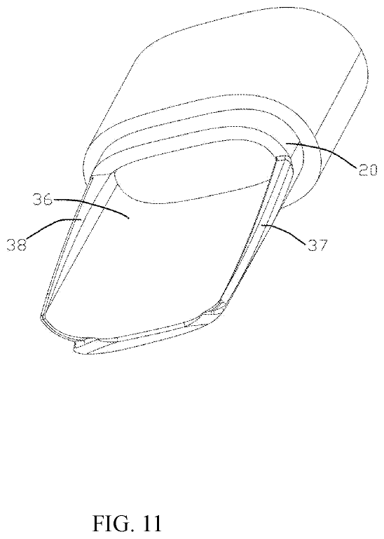

In the embodiment, as shown in FIG. 10 and FIG. 11, a first side surface 37 and a second side surface 38 are respectively disposed on two sides of the slope of the flow guide portion 20. The first side surface 37 is located on a right side of the flow guide inclined opening 36, the second side surface 38 is located on a left side of the flow guide inclined opening 36, and a horizontal height of the second side surface 38 is greater than a horizontal height of the first side surface 37, so that the water drops in the air inlet 7 easily flow to the purified water cavity along the flow guide inclined opening 36.

In other embodiments, the horizontal height of the second side surface 38 is less than the horizontal height of the first side surface 37.

Optionally, the first side surface 37 and the second side surface 38 are both obliquely disposed, and a slope of the second side surface 38 is same as a slope of the first side surface 37. Of course, the slope of the second side surface 38 may also be greater than the slope of the first side surface 37, or the slope of the second side surface 38 may be less than the slope of the first side surface 37.

In the embodiment, the air inlet 7 of the exhaust pipe body 6 is not a flat structure, and a working principle thereof may refers to a flow guiding mode of a leaf tip to water. That is, sharp positions on two sides of the first side surface 37 and the second side surface 38 cannot be symmetric. The working principle is that in a conventional flat opening or symmetrical special-shaped opening, the water drops form a water film due to a surface tension of the water drop to balance the self gravity of the water drops, so the water drops are unable to automatically flow out to block an air path, thereby hindering a proceeding of water purification.

In the embodiment, a bottom surface of the exhaust mounting hole of the partition plate 5 extends towards a direction of the purified water cavity to form the flow guide portion 20. The exhaust pipe body 6 is mounted in the exhaust mounting hole. A bottom portion of the air inlet 7 of the exhaust pipe body 6 is connected to a top portion of the flow guide inclined opening 36 of the flow guide portion 20, so that the flow guide portion 20 and the partition plate 5 are integrally formed, and the flow guide portion 20 is fixed. The flow guide portion 20 and the exhaust pipe body 6 are detachably connected to facilitate disassembly and assembly, so that a small amount of water drops in the exhaust pipe body 6 flows to the purified water cavity along the flow guide portion 20, and water crops are not prone to being accumulated in the exhaust pipe body 6.

In other embodiments, a bottom surface of the air inlet 7 of the exhaust pipe body 6 extends away from the air outlet 8 to form the flow guide portion 20. The bottom portion of the air inlet 7 of the exhaust pipe body 6 is communicated with the top portion of the flow guide inclined opening 36 on the flow guide portion 20, so that the flow guide portion 20 and the exhaust pipe body 6 are integrally formed, and a mounting process is omitted, which facilitates the disassembly and assembly. The small amount of water drops in the exhaust pipe body 6 can easily flow to the purified water cavity along the flow guide portion 20, so that the water crops are not prone to accumulate in the air inlet 7.

In the embodiment, the exhaust pipe body 6 is a conical pipe body with an inner diameter gradually increasing from the air outlet 8 to the air inlet 7, and has a good guiding effect on the small amount of water drops in the exhaust pipe body 6, which prevents the water drops from blocking the air outlet 8.

Specifically, the exhaust pipe is integrally formed and is convenient to manufacture. More specifically, the exhaust pipe body 6 comprises an intake section and an outlet section. The intake section and the an outlet section are connected and together defines the pipe cavity therein. The pipe cavity is conical. When the bottle body 1 is placed upright, a bottom portion of the pipe cavity runs through a bottom surface of the intake section to form the air inlet 7, and a top portion of the pipe cavity runs through a top surface of the exhaust section to form the air outlet 8, which improve air tightness and the exhaust efficiency. Optionally, the intake section and the exhaust section are integrally formed, which is convenient to manufacture.

In other embodiments, the intake section is detachably connected to the exhaust section in the exhaust pipe body 6.

In the embodiment, the exhaust pipe further comprises an air inlet positioning portion 32 integrally formed with the intake section of the exhaust pipe body 6. That is, the bottom portion of the pipe cavity runs through a bottom surface of the air inlet positioning portion 32 to form the air inlet 7, and an outer diameter of the air inlet positioning portion 32 is less than a maximum outer diameter of the intake section. An air inlet positioning convex ring is disposed on the air inlet positioning portion 32. A peripheral side surface of the air inlet positioning portion 32 radially protrudes to form the air inlet positioning convex ring. Therefore, the exhaust pipe body 6 is clamped in the exhaust mounting hole of the partition plate 5 through the air inlet positioning portion 32, which facilitates the effective fixation of the exhaust pipe.

Optionally, the air inlet positioning portion 32 is connected to the intake section of the exhaust pipe body 6 through a transition connecting portion, which ensures a connection strength between the air inlet positioning portion 32 and the exhaust pipe body 6.

In one specific embodiment, the air inlet positioning portion 32, the transition connecting portion, and the exhaust pipe body 6 are integrally formed, which facilitates manufacturing of the exhaust pipe, and improves stability of a structure of the exhaust pipe.

In the embodiment, a polishing layer or a water guide coating later is coated on an inner wall of the exhaust pipe body 6, which improves a smoothness of the inner wall of the exhaust pipe body 6 and prevents the water drops from hanging on the inner wall of the exhaust pipe body 6.

In the embodiment, the exhaust device further comprises a check valve 9. The check valve 9 is configured to discharge the air in the purified water cavity from the air outlet 8 of the exhaust pipe to the raw water cavity. The check valve 9 is further configured to limit the water in the raw water cavity to enter the purified water cavity from the air outlet 8 of the exhaust pipe.

That is, the check valve 9 makes the air in the purified water cavity discharge from the air outlet 8 of the exhaust pipe body 6 to the raw water cavity and limits the water in the raw water cavity from entering the purified water cavity from the air outlet 8 of the exhaust pipe body 6, which improves filtration efficiency.

In the embodiment, the check valve 9 comprises a valve cavity, a valve inlet 21, and a valve outlet 22. The valve inlet 21 is communicated with the valve outlet 22 through the valve cavity. The valve inlet 21 of the check valve 9 is communicated with the air outlet 8 of the exhaust pipe body 6. In this way, the check valve 9 is sleeved on the exhaust pipe body 6 through the valve inlet 21 to enable the exhaust port 8 to communicate with the valve outlet 22, so that the air in the exhaust pipe body 6 is discharged from the valve outlet 22 to the raw water cavity through the air outlet 8. Optionally, the valve outlet 22 in the embodiment is a normal shape, which prevents the water in the raw water cavity from entering the purified water cavity from the air outlet 8 of the exhaust pipe body 6. In other embodiments, the valve outlet 22 is of a cross shape or other shape.

In the embodiment, the exhaust pipe further comprises a valve connecting portion 33, and the valve connecting portion 33 defines a valve connecting opening. The valve connecting portion 33 is disposed on the exhaust pipe body 6 and enables the valve connecting opening to communicate with the air outlet 8. That is, the top portion of the pipe cavity runs through a top surface of the valve connecting portion 33 to form the air outlet 8. The check valve 9 is sleeved on the valve connecting portion 33 and enables the valve connecting opening to communicate with the valve outlet 22 through the valve inlet 21, so that the check valve 9 is effectively mounted on the exhaust pipe body 6.

Specifically, the valve connecting portion 33 and the exhaust pipe body 6 are integrally formed, that is, the valve connecting portion 33 is effectively fixed on the exhaust section of the exhaust pipe body 6. More specifically, the valve connecting portion 33 is of a column structure, so that the check valve 9 is well fixed on the valve connecting portion 33.

In the embodiment, a valve positioning portion is disposed on a peripheral side of the valve connecting portion 33. The valve positioning portion is configured to limit a vertical position of the check valve 9 on the valve connecting portion 33. Specifically, the valve positioning portion and the valve connecting portion 33 are integrally formed. Optionally, the valve positioning portion is disposed at a joint of the valve connecting portion 33 and the exhaust section on the exhaust pipe body 6.

In the embodiment, the check valve 9 is sleeved on the valve connecting portion 33 of the exhaust pipe through the valve connecting piece 23, which facilitates mounting and fixing of the check valve 9.

Optionally, the valve connecting piece 23 is made of soft rubber, which further improve the air tightness of the check valve 9.

In the embodiment, the exhaust device further comprises a valve covering assembly. The valve covering assembly is configured to fix the check valve 9 to the exhaust pipe and cover the check valve 9 to limit water from entering the pipe cavity from the air outlet 8. An exhaust gap is defined between the valve covering assembly and the check valve 9. The exhaust gap is configured to communicate with the air outlet 8 of the exhaust pipe.

Specifically, the valve covering assembly is configured to cover the valve outlet 22 of the check valve 9, which ensures that the air in the exhaust pipe body 6 is discharged from the exhaust gap to the raw water cavity, prevents the raw water in the raw water cavity from impacting the check valve 9, and further prevents the raw water in the raw water cavity from entering the air outlet 8 of the exhaust pipe body 6 through the valve outlet 22.

In the embodiment, the valve covering assembly comprises a positioning covering piece 30 and a positioning ring 10. The positioning covering piece 30 is configured to fix the check valve 9 on the exhaust pipe and cover the check valve 9 to limit the water from entering the pipe cavity from the air outlet 8. The exhaust gap is defined between the positioning covering piece 30 and the check valve 9. The exhaust gap is communicated with the air outlet 8 of the exhaust pipe. The positioning ring 10 is sleeved in the raw water cavity of the bottle body 1 and is connected to the positioning covering piece 30 to maintain a vertical position of the positioning covering piece 30 in the raw water cavity. In this way, the positioning covering piece 30 prevents the raw water in the raw water cavity from impacting the check valve 9, thereby blocking the raw water in the raw water cavity from entering the purified water cavity from the air outlet 8 of the exhaust pipe body 6/ Further, the impact of water wave in the raw water cavity on the check valve 9 due to shaking, falling, etc. Is avoided, avoiding a risk of raw water flowing into the purified water cavity without the filter device 2, and making the air in the exhaust pipe body 6t to be discharged from the exhaust gap to the raw water cavity.

Specifically, a bottom portion of the valve cavity runs through a bottom surface of the check valve 9 to form the valve inlet 21. A top portion of the valve cavity runs through a top surface of the check valve 9 to form the valve outlet 22. The positioning covering piece 30 covers the top portion of the valve cavity of the check valve 9 so as to effectively cover the valve outlet 22.

Specifically, the positioning covering piece 30 comprises a positioning covering groove configured to fix the check valve 9 on the exhaust pipe. The exhaust gap is formed between the positioning covering groove of the positioning covering piece 30 and the check valve 9. The exhaust gap is communicated with the air outlet 8 of the exhaust pipe through the positioning covering groove. One end of the exhaust pipe body 6 close to the check valve 9 is assembled with the positioning covering groove so that the exhaust pipe body 6 is fixed on the positioning ring 10. Atop portion of the check valve 9 disposed on the exhaust pipe body 6 is covered by a bottom surface of the positioning covering groove. In this way, fixing and covering effects of the check valve 9 are improved. A bottom surface of the positioning covering piece 30 extends toward a top surface of the positioning covering piece 30 to form the positioning covering groove.

In the embodiment, the valve covering assembly further comprises a positioning connecting piece 11. The positioning connecting piece 11 defines a positioning hole 12 and an exhaust port 13. The exhaust pipe body 6 of the exhaust device passes through the positioning hole 12 of the positioning connecting piece 11 and is clamped and fixed in the positioning covering groove of the positioning covering piece 30 through the positioning connecting piece 11. The exhaust port 13 of the positioning connecting piece 11 is communicated with the exhaust gap and enables the air outlet 8 on the exhaust pipe body 6 to communicate with the raw water cavity. Thus, the check valve 9 is effectively fixed, which prevents the check valve 9 from shaking in the positioning covering groove, and well prevents the check valve 9 from separating from the exhaust pipe body 6 and affecting the filtration efficiency.

Specifically, the check valve 9 disposed on the exhaust pipe body 6 is mounted in the positioning covering groove of the positioning covering piece 30 through the positioning connecting piece 11. The positioning covering piece 30 is configured to cover the valve outlet 22 of the check valve 9 disposed on the exhaust pipe body 6. The valve outlet 22 of the check valve 9 disposed on the exhaust pipe body 6 is communicated with the raw water cavity, so that air outlet parts of the exhaust device are effectively fixed by the valve covering assembly, and the air in the exhaust pipe body 6 is discharged to the raw water cavity through the exhaust gap. Moreover, under the action of the positioning covering piece 30, the check valve 9 is prevented from impacting by the water.

Specifically, a top portion and a bottom portion of the positioning hole 12 run through a top portion and a bottom portion of the positioning connecting piece 11. Two sides of the positioning hole 12 run through exhaust port 13 two sides of the positioning connecting piece 11 to form the exhaust port 13, which facilitates the effective fixing of the exhaust device and the effective discharge of the air.

In the embodiment, the exhaust device further comprises a water absorbing piece 24. The water absorbing piece 24 is configured to absorb the small amount of water drops formed in the air outlet 8 of the exhaust pipe body 6, which further limits the water in the raw water cavity from entering the purified water cavity through the air outlet 8 of the exhaust pipe body 6.

In the embodiment, the water absorbing piece 24 passes through the pipe cavity of the exhaust pipe body 6 and is attached to the inner wall of the exhaust pipe body 6. Two ends of the water absorbing piece 24 pass through the air inlet 7 and the air outlet 8 of the exhaust pipe body 6 and are respectively fixed at the air inlet 7 and the air outlet 8. Therefore, the water absorbing piece 24 is detachably mounted in the exhaust pipe body 6, which facilitates disassembly and assembly of the water absorbing piece 24. The water absorbing piece 24 is disposed along a flow direction of the water drops, that is, the water absorbing piece 24 is disposed along a length direction of the exhaust pipe body 6. Therefore, when the water drops in the exhaust pipe body 6 flow from the air outlet 8 to the air inlet 7 under the gravity, the water drops are effectively absorbed by the water absorbing piece 24. Specifically, the water absorbing piece 24 is strip-shaped, and the water absorbing piece 24 is disposed along the length direction of the exhaust pipe body 6, which improve adsorption efficiency of the water drops.

In other embodiments, the two ends of the water absorbing piece 24 are respectively fixed on the air inlet 7 and the air outlet 8 of the exhaust pipe body 6 by winding or bonding.

Optionally, the water absorbing piece 24 is made of cotton, cloth, nylon mesh, steel mesh, or other material that is able to guide water, which improves water guide efficiency of water drops.

In one embodiment, the exhaust device is disposed on an outer side the bottle body 1 and is configured to discharge the air in the purified water cavity into the raw water cavity.

In another embodiment, the exhaust device is disposed on the outer side of the bottle body 1 and is configured to transmit air outside the bottle body 1 into the raw water cavity.

In the embodiment, the automatic water filtering purifying bottle further comprises a raw water opening lid 25 detachably connected to the bottle body 1 to open and close the raw water opening 3. Specifically, the raw water opening lid 25 is screwed with the bottle body 1, which facilitates disassembly and assembly of the raw water opening lid 25.

In the embodiment, the automatic water filtering purifying bottle further comprises a purified water opening lid 14. The purified water opening lid 14 is detachably connected to the bottle body 1 to open and close the purified water opening 3.

In the embodiment, the purified water opening lid 14 comprises a connecting cover 15 and a flipping cover 16. The connecting cover 15 is detachably mounted on the purified water opening 4 of the bottle body 1. The flipping cover 16 is flippable on the connecting cover 15 and is detachably connected to the connecting cover 15 to open and close the purified water opening 4. Specifically, the connecting cover 15 is screwed with the bottle body 1 to facilitate disassembly and assembly of the purified water opening lid 14.

In the embodiment, the purified water opening lid 14 further comprises a screwing cap 17. A movable through hole is defined on the flipping cover 16. A connecting hole 18 is defined on the connecting cover 15. The connecting hole 18 is communicated with the purified water cavity through the purified water opening 4. The screwing cap 17 is rotatable in the movable through hole to be connected to or separated from the connecting cover 15, so the connecting hole 18 is controlled to open or close. In this way, outflow of the purified water in the purified water cavity is facilitated.

Specifically, a sealing plug 27 is disposed inside the screwing cap 17, and a shape of the sealing plug 27 is matched with a shape of the connecting hole 18, which improves a sealing performance. Optionally, the sealing plug 27 is made of the soft rubber, which also improves the sealing performance.

In the embodiment, a baffle plate 34 is disposed inside the screwing cap 17. The baffle plate 34 rotates in the movable through hole of the flipping cover 16 along with the screwing cap 17 and is configured to cover the connecting hole 18 of the connecting cover 15, thereby preventing external dust from entering the bottle body 1 through the connection hole 18, so as to realize a dust-proof effect.

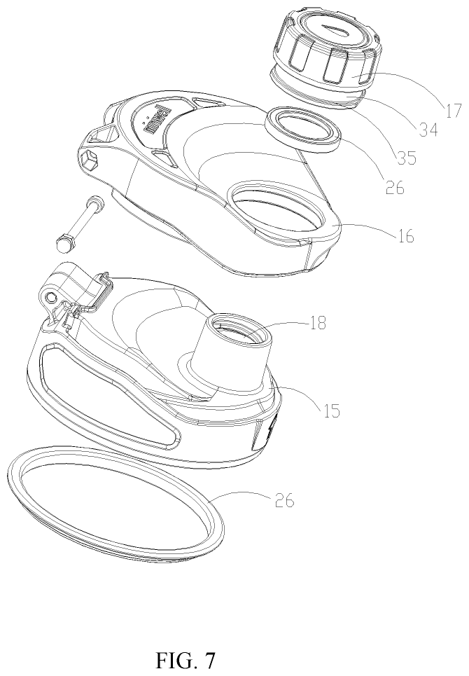

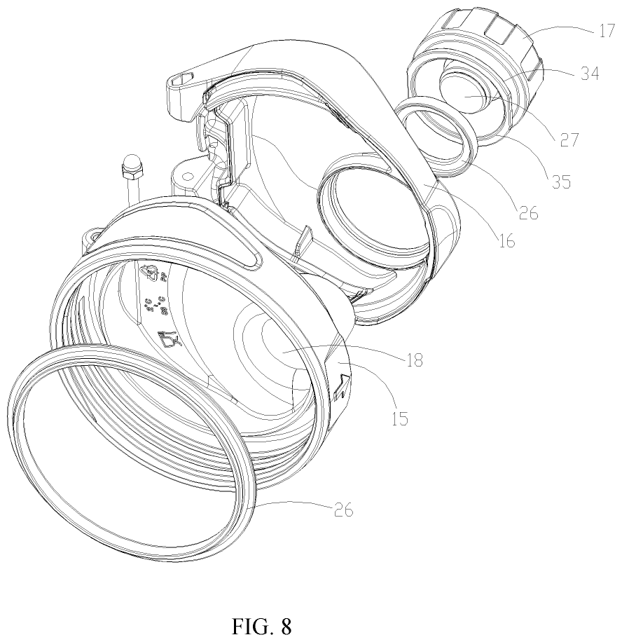

Specifically, as shown in FIGS. 7 and 8, the baffle plate 34 is an inner ring extending downward from a bottom circumference of the screwing cap 17, and the sealing plug 27 is disposed on an inner side of the baffle 3 plate 4. By such arrangement, the manufacture of the baffle plate 34 is facilitated.

Specifically, as shown in FIGS. 7 and 8, a limiting ring 35 is disposed on the baffle plate 34. The limit ring 35 is configured to limit the screwing cap 17 from separating from the movable through hole on the flipping cover 16. Optionally, the limiting ring 35 is a convex ring extending radially from a bottom peripheral side of the baffle plate 34, that is, an outer diameter of the limiting ring 35 is greater than an inner diameter of the movable through hole. An inner diameter of the limiting ring 35 is same as an inner diameter of the baffle plate 34. The inner diameter of the limiting ring 35 and the inner diameter of the baffle plate 34 are respectively slightly greater than an outer diameter of the connecting hole 18, so that the screwing cap 17 is prevented from separating from the movable through hole and the baffle plate 34 is able to cover the connecting hole 18.

In the embodiment, the screwing cap 17 and the connection cover 15 are connected by threads. The sealing plug 27 of the screw cap 17 defines external threads, and an inner wall of the connecting hole 18 of the connecting cover 15 defines internal threads. By arranging the internal threads on the inner wall of the connecting hole 18, when the connecting hole 18 of the connecting cover 15 is exposed for drinking, the internal threads on the connecting hole 18 do not contact the mouth, bring a good drinking experience.

A connecting head is dispose on the connecting cover 15. The connecting head is a cylinder extending upward from a top surface of the connecting cover 15. A top portion and a bottom portion of the connecting hole 18 run through a top portion and a bottom portion of the cylinder respectively, which is convenient for drinking water. The connecting hole 18 also helps to the assembly of the connecting head and the sealing plug 27, saving material cost of the sealing plug 27 and the screwing cap 17.

In the embodiment, sealing rings 26 are respectively disposed between the bottle body 1 and the raw water opening lid 25, the bottle body 1 and the purified water opening lid 14, the filter device 2 and the partition plate 5, which improve a sealing performance between the raw water cavity and the purified water cavity.

Specifically, in the purified water opening lid 14, a first sealing ring 26 is disposed between the connecting cover 15 and the bottle body 1. Two second sealing rings 26 are disposed between the filter device 2 and the partition plate 5, and the two second sealing rings 26 further ensure a sealing performance of the filter element corresponding to the raw water cavity and the purified water cavity, thereby preventing leakage of filtration.

Optionally, the sealing rings 26 are silicone rings, which further improve the sealing performance.

In the embodiment, the automatic water filtering purifying bottle further comprises a handle 28 disposed on the raw water opening lid 25, so as to facilitate carrying of the automatic water filtering purifying bottle.

In other embodiments, one handle 28 is disposed on the bottle body 1 or the purified water opening lid 14, or handles 28 are disposed on at least two of the bottle body 1, the purified water opening lid 14, and the raw water opening lid 25.

Optionally, the handle 28 in the embodiment is hinged to the raw water opening lid 25 for easy storage. In other embodiments, the handle 28 is fixedly assembled with the raw water opening lid 25, the bottle body 1, or the purified water opening lid 14.

In the embodiment, an anti-slip portion 29 is disposed on a surface of the bottle body 1 to facilitate holding and use of the bottle body 1. Specifically, the anti-slip portion 29 is a sleeve sleeved on the surface of the bottle body 1. Anti-slip ribs are disposed on the sleeve. Of course, the anti-slip portion 29 may also be raised anti-slip ribs disposed on the surface of the bottle body 1.

Optionally, a groove is formed on the surface of the bottle body 1, and the anti-slip portion 29 is sleeved on the groove of the bottle body 1 to facilitate effective fixing of the anti-slip portion 29.

When assembling, the filter device 2 is mounted in the filter mounting hole of the partition plate 5. The water absorbing piece 24 is inserted into the pipe cavity of the exhaust pipe body 6 and the two ends of the water absorbing piece 24 respectively pass through the air inlet 7 and the air outlet 8. Then the air inlet positioning portion 32 on the exhaust pipe is inserted into the exhaust mounting hole of the partition plate 5, and then a first end of the water absorbing piece 24 is clamped between the air inlet positioning portion 32 and the inner wall of the exhaust mounting hole on the partition plate 5. The check valve 9 is sleeved on the valve connecting portion 33 of the exhaust pipe through the valve connecting piece 23, and the second end of the water absorbing piece 24 is clamped between the valve connecting piece 23 and the valve connecting portion 33. The two ends of the water absorbing piece 24 are effectively fixed at the air inlet 7 and the air outlet 8 and the surface of the water absorbing piece 24 is attached to the inner wall of the pipe cavity of the exhaust pipe body 6. The check valve 9 disposed on the exhaust pipe passes through the positioning hole 12 of the positioning connecting piece 11 and makes the valve outlet 22 to be communicated with the raw water cavity through the exhaust port 13. The positioning ring 10 is sleeved in the raw water cavity of the bottle body 1 and the check valve 9 is clamped and fixed in the positioning covering piece 30 through the positioning connecting piece 11. The anti-slip portion 29 is sleeved on the surface of the bottle body 1, and the raw water opening lid 25 and the purified water opening lid 14 are respectively mounted on the raw water opening 3 and the purified water opening 4 of the bottle body 1.

When in use, the bottle body 1 is placed upright, and the raw water opening lid 25 is removed to expose the raw water opening 3. The raw water to be filtered enters the raw water cavity from the raw water opening 3 of the bottle body 1 and enters the filter device 2 from the water inlet end of the filter device 2. Under the action of the filter device 2, the raw water in the raw water cavity is filter under the gravity. The purified water filtered by the filtering device 2 enters the purified water cavity from the water outlet end of the filter device 2. The air in the purified water cavity enters the exhaust pipe body 6 from the air inlet 7 of the exhaust pipe body 6, and then is discharged from the check valve 9 through valve outlet 22. Finally, the air is discharged from the exhaust port 13 of the positioning connecting piece 11 to the raw water cavity. When it is needed to use or drink the purified water, the raw water opening lid 25 is covered to close the raw water opening 3, and the bottle body 1 in turned upside down. That is, the first end of the bottle body 1 close to the raw water cavity faces downward and the second end of the bottle body 1 close to the purified water cavity faces upward. The screwing cap 17 is unscrewed to separate the screwing cap 17 from the connecting cover 15. At this time, the flipping cover 16 is flipped from the connecting cover 15, and the connecting hole 18 on the connecting cover 15 is exposed, so that the purified water in the purified water cavity flows out from the connecting hole 18.

On the premise of no conflict, those skilled in the art can freely combine and superimpose the above additional technical features.

The above descriptions are only optional embodiments of the present disclosure. The technical solution achieving same purpose of the present disclosure by means basically the same as that of the present disclosure should fall within the protection scope of the present disclosure.

What is claimed is:

1. An automatic water filtering purifying bottle, comprising:
a bottle body, and
a filter device;
wherein the bottle body comprises a raw water cavity and a purified water cavity; the raw water cavity and the purified water cavity sequentially disposed along an axis direction; the bottle body defines a raw water opening and a purified water opening; the raw water opening is capable of being opened and closed; the raw water opening is configured to communicate with the raw water cavity; the purified water opening is capable of being opened and closed; the purified water opening is configured to communicate with the purified water cavity; the filter device is configured to filter water in the raw water cavity and is communicated with the raw water cavity and the purified water cavity.

2. The automatic water filtering purifying bottle according to claim 1, wherein the raw water cavity and the purified water cavity in the bottle body are separated by a partition plate; the partition plate defines a filter mounting hole; the filter device is fixed in the filter mounting hole of the partition plate.

3. The automatic water filtering purifying bottle according to claim 1, wherein the automatic water filtering purifying bottle further comprises an exhaust device; the exhaust device is configured to maintain an air pressure balance in the raw water cavity and the purified water cavity.

4. The automatic water filtering purifying bottle according to claim 3, wherein the exhaust device comprises an exhaust pipe; the exhaust pipe is disposed in the raw water cavity and the purified water cavity of the bottle body; the exhaust pipe comprises a pipe cavity, an air inlet, and an air outlet; the air inlet is communicated with the air outlet through the pipe cavity; the air inlet is configured to communicate with the purified water cavity; the air outlet is configured to communicate with the raw water cavity.

5. The automatic water filtering purifying bottle according to claim 4, wherein a polishing layer or a water guide coating later is coated on an inner wall of the exhaust pipe.

6. The automatic water filtering purifying bottle according to claim 4, wherein the exhaust device further comprises a check valve; the check valve is configured to discharge air in the purified water cavity from the air outlet of the exhaust pipe to the raw water cavity; the check valve is further configured to limit the water in the raw water cavity to enter the purified water cavity from the air outlet of the exhaust pipe.

7. The automatic water filtering purifying bottle according to claim 6, wherein the exhaust device further comprises a valve covering assembly; the valve covering assembly is configured to fix the check valve to the exhaust pipe and cover the check valve to limit water from entering the pipe cavity from the air outlet; an exhaust gap is defined between the valve covering assembly and the check valve; the exhaust gap is configured to communicate with the air outlet of the exhaust pipe.

8. The automatic water filtering purifying bottle according to claim 7, wherein the valve covering assembly comprises a positioning covering piece and a positioning ring; the positioning covering piece is configured to fix the check valve on the exhaust pipe and cover the check valve to limit the water from entering the pipe cavity from the air outlet; the exhaust gap is defined between the positioning covering piece and the check valve; the exhaust gap is communicated with the air outlet of the exhaust pipe; the positioning ring is sleeved in the raw water cavity of the bottle body and is connected to the positioning covering piece to maintain a vertical position of the positioning covering piece in the raw water cavity.

9. The automatic water filtering purifying bottle according to claim 1, wherein automatic water filtering purifying bottle further comprises a purified water opening lid; the purified water opening lid is detachably connected to the bottle body to open and close the purified water opening.

10. The automatic water filtering purifying bottle according to claim 9, wherein the purified water opening lid comprises a connecting cover, a flipping cover, and a screwing cap; the connecting cover is detachably mounted on the purified water opening of the bottle body; a movable through hole is defined on the flipping cover; a connecting hole is defined on the connecting cover; the connecting hole is communicated with the purified water cavity through the purified water opening; the screwing cap is rotatable in the movable through hole to be connected to or separated from the connecting cover, so the connecting hole is controlled to open or close.
